(19) United States
(12) Patent Application Publication
(10) Pub. No.: US 2026/0216742 A1
(43) Pub. Date: Jul. 30, 2026

(54) FLOOR CLEANING PRODUCT

(71) Applicant: The Procter & Gamble Company, Cincinnati, OH (US)

(72) Inventors: Immacolata PRISCO, Brussels (BE); Nevena LUKIC, Brussels (BE); Varlik KIRAN, Temse (BE); Francis Marcel Catharina VANDECRUYS, Retie (BE); Vanessa ROSATI, CRISNÉE (BE); Aicha DKIDAK, Brussels (BE); Matthew Joshua BREWER, Deerfield Township, OH (US); Fernando Ray TOLLENS, Cincinnati, OH (US); Seth Charles COUCH, Moores Hill, IN (US); Laura ORLANDINI, LE MONT-SUR-LAUSANNE (CH)

(21) Appl. No.: 19/039,249

(22) Filed: Jan. 28, 2025

(51) Int. Cl. B05B 11/04

(52) U.S. Cl. CPC B05B 11/047; B05B 11/048

(57) ABSTRACT

A floor cleaning product including a container that has a convex front panel and an opposite rear panel. The rear panel has a recess sized and dimensioned to receive part of the distal phalanxes of digits two through five of an adult human hand. The product further includes a flip top closure engaged with the container. The flip top closure has a plurality of small apertures through which a liquid floor cleaning composition contained in the container is dispensed.

### FIELD OF THE INVENTION

A floor cleaning product including a squeezable container, a flip top closure, and liquid cleaning product contained in the container.

### BACKGROUND OF THE INVENTION

Cleaning the floors of domiciles can be a challenging project for many people. Many domiciles have, in certain locations, concrete, ceramic tile, cork, and or hardwood flooring. One approach for cleaning such floors is to use a mop and bucket. This approach to cleaning is labor intensive and often yields unsatisfactory results. Another approach is to use a mop having a liquid dispenser onboard the mop. The user activates the liquid dispenser to release or spray cleaning composition onto the floor and the floor is wiped with disposable or reusable wipe attached to the mop. This approach can be quite effective but requires the user of the mop to push around the weight of the cleaning composition stored in a container mounted on the mop.

Another approach is to provide for a cleaning composition that the user can pour or squirt onto the floor by hand. Then the user can use a separate mop to mop the wetted floor. One challenge with floor cleaning products that are applied by hand to the floor is that it can be difficult for users of such products to distribute the cleaning composition sufficiently evenly and broadly enough and in the desired quantity. Pouring liquids onto the floor is a notoriously difficult process for the user to control. Push pull type container closures that also function as a dispenser typically deliver only a single stream of product when the container is inverted and optionally squeezed.

With these limitations in mind, there is a continuing unaddressed need for a floor cleaning product that the user can easily dispense onto the floor in controllable manner.

### SUMMARY OF THE INVENTION

A floor cleaning product comprising: a container comprising: an open end surrounding a longitudinal axis passing through said open end; a neck extending from said open end and around said longitudinal axis; a closed end opposite said open end, wherein said longitudinal axis extends through said closed end, wherein said container has a transverse section midway between said open end and said closed end, wherein said transverse section is orthogonal to said longitudinal axis; a front panel extending between a pair of sidewalls, wherein between said sidewalls along said transverse section said front panel is convex relative to said longitudinal axis; and a rear panel opposite said front panel and extending between said sidewalls, wherein said rear panel has a recess sized and dimensioned to receive part of distal phalanxes of digits two through five of an adult human hand, wherein said container has a container height measured along said longitudinal axis from said closed end to said open, wherein said recess extends in a direction aligned with said longitudinal axis by from about 25% to about 60% of said container height; a flip top closure comprising: a top profile having an exterior surface and interior surface opposite said exterior surface; a hinge engaging said top profile to a main body; an outlet face oriented towards said top profile, wherein said outlet face comprises from about 6 to about 10 apertures, wherein each of said apertures has a diameter from about 0.3 mm to about 1.5 mm; a skirt extending from said main body and oriented away from said top profile, wherein said skirt has a skirt interior surface oriented towards said longitudinal axis, wherein said skirt interior surface is engaged with said neck; and a liquid floor cleaning composition comprising: 0.02% to 0.2% nonionic surfactant by weight of said composition; 0.05% to 0.5% perfume by weight of said composition; and at least 95% water by weight of said composition; wherein said composition has a pH from 4.5 to 8.5.

### BRIEF DESCRIPTION OF THE DRAWINGS

FIG. 1 is a container.

FIG. 2 is a top view of a cross section of the container at the transverse section.

FIG. 3 is a flip top closure.

FIG. 4 illustrates the use of the container and flip top closure to dispense the liquid floor cleaning composition.

### DETAILED DESCRIPTION OF THE INVENTION

### Container

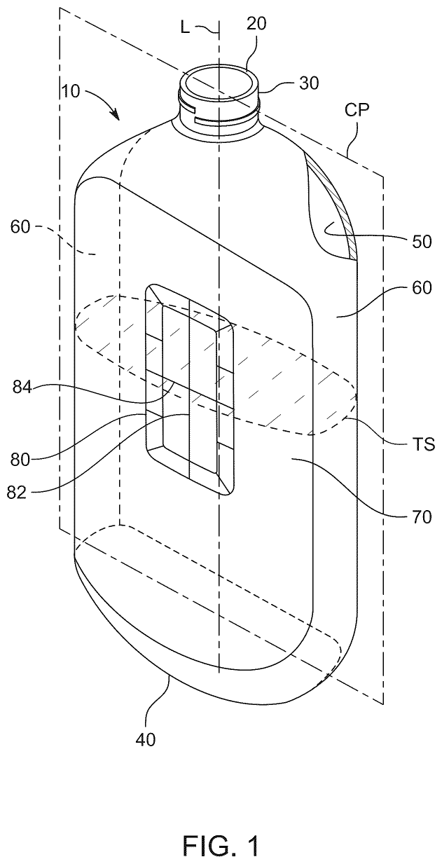

The liquid floor cleaning composition can be contained in a container. The container can be an injection molded container, an injection blow molded container, an injection stretch blow molded container. The constituent material of the container can be polyethylene, polypropylene, polyethylene terephthalate, or other material that is used to fabricate flexible plastic containers. The container 10 can comprise an open end 20 surrounding a longitudinal axis L passing through the open end 20 (FIG. 1). The container can comprise a neck 30 extending from the open end 20. The neck 30 can extend around the longitudinal axis L.

The container 10 can comprise a closed end 40 opposite the open end 20. The longitudinal axis L can extend through the closed end 40. When not in use, the container 10 can be designed so that the closed end 40 can rest stably on a flat surface, for example a floor, shelf, countertop or the like. Midway between the open end 20 and the closed end 40, the container 10 can have a transverse section TS, the transverse section TS being orthogonal to the longitudinal axis L.

The container 10 can comprise a front panel 50 extending between a pair of sidewalls 60. Between the sidewalls 60, the transverse section TS can be convex relative to the longitudinal axis L. The sidewalls 60 can be curved panels or have a complex geometry. For example, the sidewalls 60 may be concave towards the longitudinal axis L. Optionally, the sidewalls 60, can have a complex geometry that is a combination of various portions that are convex and various portions that are concave relative to the longitudinal axis L. When the container 10 is used to dispense the cleaning composition contained therein, the front panel 50 can be pressed by the user to deform the front panel 50 towards the longitudinal axis L.

The container 10 can further comprise a rear panel 70 opposite the front panel 50 and extending between the sidewalls 60. The rear panel 70 can have a recess 80 sized and dimensioned to receive part of the distal phalanxes of digits two through five of an adult human hand. A recess 80 sized and dimensioned as described herein, can help the user grip the container 10 when he or she squeezes the container 10 to dispense the cleaning composition contained therein. The recess 80 can extend in a direction aligned with the longitudinal axis L by from about 25% to about 60% of the container height, the container height being measured along the longitudinal axis L from the closed end 40 to the open end 20. The container height can be from about 160 mm to about 280 mm, optionally from about 180 mm to about 260 mm, optionally from about 200 mm to about 240 mm, optionally from about 210 mm to about 230 mm, optionally about 220 mm.

The user can dispense the cleaning composition by opening a flip top closure that is engaged with the neck 30 while the container 10 is in an upright position with the open end 20 above the closed end 40. The user can then grasp the container 10 by placing his or her thumb on the front panel 50 and his or her distal phalanxes of digits two through five into the recess 80. The user can then turn the container 10 so that the closed end 40 is above the open end 20. The cleaning composition contained in the container 10 can be dispensed by gravity driven flow. Optionally, the user can squeeze the container 10 between his or her thumb and fingers to dispense the cleaning composition. Force applied by the user's thumb can deform the front panel toward the longitudinal axis L which acts to reduce the interior volume of the container 10, thereby forcing the cleaning composition out of the container 10 through the flip top closure. A greater flow rate of the cleaning composition from the container 10 is possible by squeezing the container 10 as compared to gravity flow since under gravity driven flow vacuum developed within the container may inhibit flow of cleaning composition from the container 10.

At least a portion of the recess 80 can be coincident with the transverse section TS. Such an arrangement provides for at least a portion of the recess 80 being positioned at mid-height of the container 10. That can make the container 10 easy for the user to grasp. After some volume of the cleaning composition has been dispensed from the container 10, when the container 10 is upside down, the center of mass of the cleaning composition tends to become positioned nearer to the open end 20 as compared to when a greater quantity of cleaning composition is contained in the container 10. As such, it can be desirable to position the recess 80 such that the recess 80 is intersected by the transverse section TS and a majority of the recess 80 is nearer to said open end 20 than the closed end. Optionally, a majority of the recess 80 can be positioned between the transverse section TS and the open end 20. These arrangements are practical since as cleaning composition is dispensed from the container 10, when the container 10 is upside down, the center of mass of the cleaning composition moves towards the open end 20. From an ergonomic perspective, it can be desirable to have the recess 80 near to the center of mass of the cleaning composition as the cleaning composition is dispensed since such an arrangement it can be easier for a user to manipulate the container 10.

The recess 80 can have a depth to accommodate the users fingers as described above. The maximum recess depth relative to portions of the rear panel 70 immediately surrounding the recess 80 can be from about 4 mm to about 8 mm. Such a maximum depth is thought to with a typical range that users are able to flex, or comfortably flex, their distal phalanxes of digits two through five and apply force to the recess 80 to deform the container 10 and dispense cleaning composition therefrom.

To accommodate the users distal phalanxes of digits two through five, the recess 80 can have a recess height 82 measured parallel to the longitudinal axis L that is from about 50 mm to about 130 mm, optionally from about 60 mm to about 130 mm, optionally about 60 mm, optionally about 62 mm. Optionally, the maximum recess depth relative portions of the rear panel 70 immediately surrounding the recess can be from about 3% to about 13%, optionally about 6% to about 10%, optionally about 8%, of the recess height 82. In combination of this recess height and maximum recess depth can be ergonomic for a wide range of male and female adults.

The recess 80 can have a maximum recess width 84 measured orthogonal to the longitudinal axis L that is from about 20 mm to about 40 mm, optionally from about 20 mm to about 30 mm, optionally about 27 mm. Such a maximum recess width 84 can accommodate the users distal phalanxes of digits two through five.

The recess 80 can have a ratio of recess height 82 to maximum recess width 84 that is from about 3 to about 7, optionally from about 3 to about 6.5, optionally from about 3 to about 6, optionally from about 4 to about 5.

The container 10 can have a first interior volume in a free standing condition that is from about 200 mL to about 1500 mL, optionally from about 400 mL to about 1300 mL, optionally from about 500 mL to about 1200 mL. The free standing condition is the when the container 10 is empty and its closed end is seated on a flat horizontal surface.

The container 10 can have a wall thickness between the neck 30 and the closed end 40 that is from about 0.20 mm to about 0.80 mm. The container 10 can have a wall thickness minimum of about 0.20 mm. Without being bound by theory, it is thought that such a thin walled plastic container 10 can be relatively easily deformed by the user when he or she squeezes the container 10 to dispense the cleaning composition.

The container 10 can have a coronal plane CP between the front panel 50 and the rear panel 70. The coronal plane can pass through the longitudinal axis L. The coronal plane CP divides the container 10 into a front section and a rear section. The container 10 can have a median plane MP between the sidewalls 60. The median plane MP can pass through the longitudinal axis L. The median plane can divide the container 10 in left and right sides. The container 10 can by asymmetric or symmetric with respect to the median plane MP.

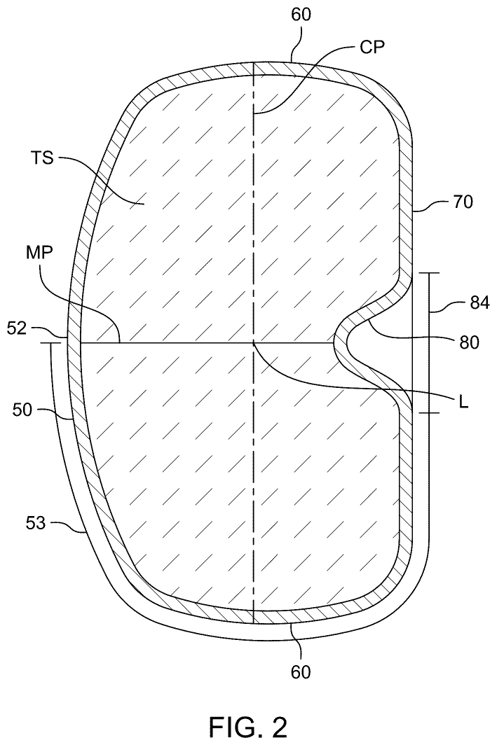

The front panel 50 can have a center 52 on the transverse section TS midway between the sidewalls 60, as shown in FIG. 2, which is a top view of a cross section of a container 10 at the transverse section TS. Interior to the container 10, the recess 80 can be from about 40 mm to about 70 mm, optionally from about 40 mm to about 60 mm, optionally from about 45 mm to about 55 mm away from the front panel 50 as measured through and orthogonal to the longitudinal axis L. Such a separation between the interior surfaces of the front panel 50 and the recess 80 can be within a range that the user can ergonomically apply a desirable and sufficient squeezing force to discharge cleaning composition from the container 10. At the transverse section TS, the ratio of the interior distance between the recess 80 and the front panel 50 as measured through and orthogonal to the longitudinal axis L and the maximum recess depth can be from about 5 to about 17, optionally from about 8 to about 12, optionally about 11.

The container 10 can have a grip distance 53 from the center 52 to the recess measured along the transverse section TS exterior of the container that is from about 90 mm to about 140 mm, optionally from about 100 mm to about 130 mm, optionally from about 115 mm to about 125 mm, optionally about 115 mm. This range ergonomically accommodates the users hand span between the thumb, which is used to apply force to the front panel 50, and the distal phalanxes of digits two through five which are used to apply force to the recess 80.

### Flip Top Closure

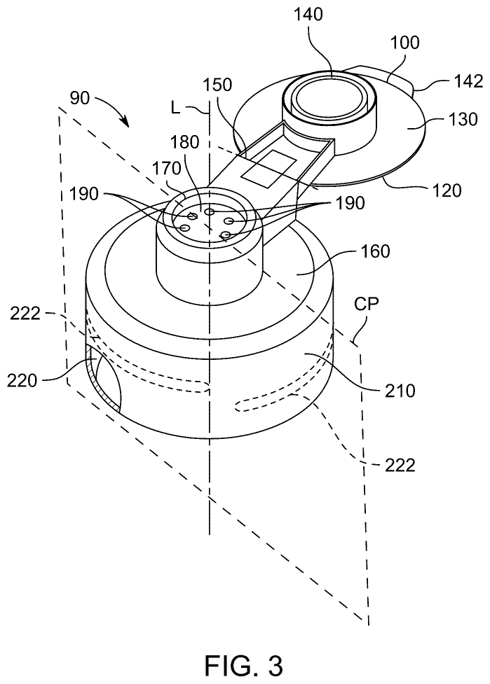

A flip top closure 90 can be provided as a closure that can be engaged with the neck 30 of the container 10 (FIG. 3). The flip top closure 90 can comprise a top profile 100 having an exterior surface 120 and an interior surface 130 opposite the exterior surface 120. The interior surface 130 is oriented towards the main body 160 and abutment 170 when the top profile 100 is in the closed position. The exterior surface 120 is oriented away from the main body 160 and abutment 170 when the top profile 100 is in the closed position.

The flip top closure 90 can optionally have a spud 140 projecting from the interior surface 130. A hinge 150 can be provided to engage the top profile 100 to a main body 160 of the flip top closure 90. The flip top closure 90 can be opened and closed by rotating the top profile 100 about the hinge 150. The hinge 150 can be a living hinge, which is a hinge that has high potential energy position between two low potential energy position, i.e. as the hinge 150 is rotated through its designed range of motion the hinge transitions from a relatively low potential energy state to a relatively higher potential energy state and with further rotational movement in the same direction transitions to a relatively low potential energy state.

The main body 160 can optionally comprise an abutment 170. The abutment 170 can extend around the longitudinal axis L. When the flip top closure 90 is in a closed position, the abutment 170 can be sealingly engaged with the spud 140. The abutment 170 can be a cylindrical section or a cylindrical section having a lip extending in a direction away from the longitudinal axis L. The abutment 170 can have an inside diameter from about 7 mm to about 20 mm, optionally about 13 mm. The abutment 170 can have a wall thickness from about 0.5 mm to about 2 mm. The spud 140 can have an outer diameter that is the same or slightly larger than the inside diameter of the abutment. Together, the spud 140 and the abutment 170 can constitute a plug seal. Optionally, a gripping flange 142 can project away from the top profile 100. The gripping flange 142 can engage with a portion of the main body 160 to help maintain the top profile 100 in the closed condition. The apertures 190 can be inboard of the abutment 170.

When the cleaning composition is not being used, the flip top closure 90 can be positioned in a closed condition. When the user desires to dispense the cleaning composition from within the container 10, the user can flip open the flip top closure 90 by grasping or pushing on the top profile 100 in a direction away from the main body 160 to rotate the top profile 100 about the hinge 150 to open the flip top closure 90. If the flip top closure 90 includes a spud 140 and abutment 170, by that motion of the top profile 100, the spud 140 can be disengaged with the abutment 170, which can open a pathway or pathways for the cleaning composition to pass through the flip top closure 90.

The flip top closure 90 can have an outlet face 180 oriented towards the top profile 100 when the top profile 100 is in a closed position. Optionally, the outlet face 180 can be within the area peripherally bounded by the optional abutment 170. The outlet face 180 can comprise from about 6 to about 10 apertures 190 that are inboard of the abutment 170. Each of the apertures 190 can have a diameter from about 0.3 mm to about 1.5 mm, optionally from about 0.6 mm to about 1 mm, optionally from about 0.6 mm to about 0.8 mm. The quantity of and diameter of the apertures 190 can provide for balance between allowing an acceptably limited amount of free flow of the cleaning composition through the apertures 190 and allow for a large enough volume of cleaning composition to be dispensed with the user squeezes the container 10 to dispense the desired quantity of cleaning composition onto the surface that is to be cleaned. The plurality of apertures 190 can be concentrically positioned around the longitudinal axis L or some other common center point.

A skirt 210 can extend from the main body 160 and be oriented away from the top profile 100. The skirt 210 can have a skirt interior surface 220 that is oriented towards the longitudinal axis L. The skirt interior surface 220 of the skirt 210 can be engaged with the neck 30. The interior surface 220 can include threads 222 that are engaged with complementary threads 222 on the neck 30 of the container 10. Optionally, the skirt interior surface 220 can be glued, thermally bonded, or friction fitted to the neck 30 of the container. The skirt interior surface 220 and neck 30 can comprise an annular projection and annular bevel into which the annular projection fits, sometimes referred to as an interference or snap ring system, to engage the skirt interior surface 220 to the neck.

The flip top closure 90 can be an injection molded part having a constituent material that is polypropylene, polyethylene, nylon, or other plastic material, or combinations thereof, from which flip top closures can be fabricated.

The top profile 100 can be rotatable about the hinge 150 in a direction of the rear panel 70. That is, the hinge 150 and the rear panel 70 are on the same side of the coronal plane CP (i.e. both are together on one side of the coronal plane CP). In other words, the hinge 150 and the front panel 50 are on opposite sides of the coronal plane CP. The hinge 150 can be generally aligned with the planar orientation of the rear panel 70. Optionally, the hinge 150 can be parallel to the coronal plane CP. To open the flip top closure 90, the top profile 100 is rotated about the hinge 50 from a closed position in which the spud 140 is engaged with the abutment 170 to an open position in which the top profile is oriented in a rearward direction (i.e., the direction that the exterior surface of the rear panel 70 is generally oriented) relative to the longitudinal axis L. The front panel 50 can be considered to face a frontward direction of the product relative to the longitudinal axis L and the rear panel 70 can be considered to face a rearward direction of the product relative to the longitudinal axis L and the hinge 50 can be positioned towards the rearward direction of the product relative to the longitudinal axis L. Optionally, the hinge 150 can be positioned within plus or minus 45 degrees of the median plane MP as measured about the longitudinal axis L. The rotational axis of the hinge 150 can be at an angle from 45 degrees to 90 degrees from the median plane MP. Optionally, the hinge 150 can be within 0 to 45 degrees of being parallel to the coronal plane CP.

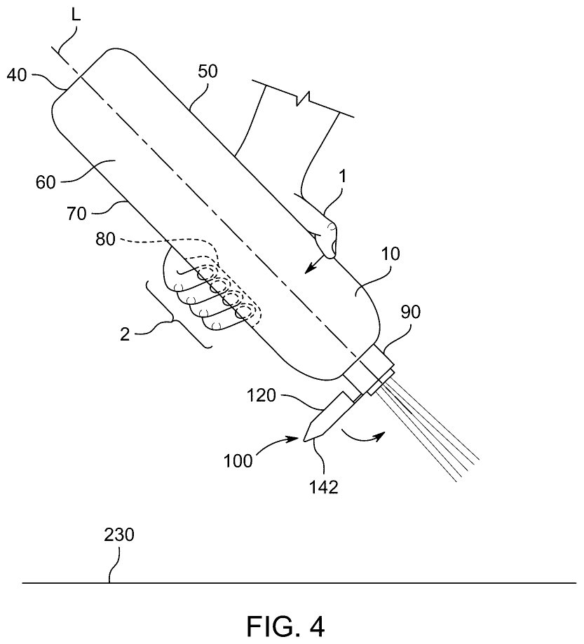

Orienting the hinge 150 towards the rear panel 70 side of the container 10 positions the flip top closure 90 such that when the user is dispensing the cleaning composition from the container 10 with the container 10 in an ergonomic position for the user, the top profile 100 does not obstruct the user's view of the cleaning composition exiting the flip top closure 90. When the user dispenses the cleaning composition by squeezing the container, the user can position the container 10 so that the recess 80 is generally oriented downwardly and the front panel 50 is generally oriented upwardly (FIG. 4). This is an ergonomic position for the user to squeeze the container 10 by pressing the front panel 50 with his or her thumb 1 while gripping the recess 80 with his or her other fingers 2, his or her forearm and hand being position so that his or her digit one, that is thumb, is above or generally elevated over his or her digits two through five, that is other fingers. By positioning the flip top closure 90 such that the top profile 100 rotates about the hinge 150 in a direction of the rear panel 70, when the user is dispensing the cleaning composition by squeezing the container, the user's view of the cleaning composition exiting the flip top closure 90 is unobstructed by the top profile 100. This allows the user to more accurately aim the flow of the cleaning composition exiting the flip top closure 90 towards the target on the surface 230 to which the cleaning composition is being applied. Moreover, the unobstructed view helps the user judge the quantity of cleaning composition being dispensed and the user can alter the amount of squeezing force applied to alter the rate and total quantity of cleaning composition dispensed.

### Container Force at 25 mm of Deformation

The Force at 25 mm of Deformation can be used to characterize the deformability, or squeezability, of the container under compressive forces. The Force at 25 mm of Deformation is, without being bound by theory, thought to reasonably characterize the squeezability of the container by a user of the cleaning product.

The Force at 25 mm of Deformation test is performed on containers that are at least three days old to minimize the effects of shrinkage that may occur after manufacturing. This test is conducted in a climate-controlled laboratory, where the environmental conditions are stabilized at 23° C. with 50% relative humidity (RH).

The compression tester used for this assessment is, or has equivalent capabilities of, the LRX Plus model from Lloyd, equipped with a 500 N load cell. In the vertical position, a rod having a diameter of 10 mm and a flat end oriented towards the container to be tested is attached to the load cell to apply force transmitted through the load cell from the compression tester. A horizontal flat plate is fixed to the lower part of the instrument, providing a stable platform to support the container during compression. The plate is large enough such that the entirety of the container can lie within the peripheral boundary of the plate.

The container is placed on the plate lying on its back panel. The back panel is opposite the front panel. The back panel is the panel having the recess that is sized and dimensioned to receive part of the distal phalanxes of digits two through five of an adult human hand. The container is positioned such that the rod is directed towards the midpoint of the front panel located midway between the neck ring of the container and the closed end and midway between the sidewalls.

The flat end of the rod is seated at the midpoint of the front panel located midway between the neck ring of the container and the closed end and midway between the sidewalls by applying a preload of 0.5 N. The compression tester is then used to compress the container at the rate of 500 mm/s by applying force to the rod. The force in Newtons applied to the container at a deformation of 25 mm+1 mm is recorded as the Force at 25 mm of Deformation.

### Container Elasticity Index

The Container Elasticity Index can be used to characterize the squeezability of the container. The Container Elasticity Index is, without being bound by theory, thought to reasonably characterize the squeezability of the container by a user of the cleaning product.

The Container Elasticity Index is measured on a container that is at least three days old to minimize the effects of shrinkage that may occur after their production. The test environment is maintained at a room temperature of 20 C±1 C, a relative humidity between 30% and 60%, and ambient atmospheric pressure.

To begin, water having a density of 1.000±0.002 g/mL, measured at 20° C., is added to a beaker having a minimum volume of 3 liters. The beaker must be sufficiently tall to allow the open end of the container to be fully submerged in the water when the container is in an upright position. The closure of the container is removed and set aside. If a shrink sleeve is engaged with the container, the shrink sleeve is removed and set aside. Any other label affixed to (e.g. adhesive label) or integrally formed as part of the container (e.g. in mold label) is left engaged with the container during measurement of the Container Elasticity Index.

The container is emptied of its contents and equilibrated with the test environment. The weight of the empty container is measured using a laboratory balance having an accuracy of 0.01 g and recorded.

Next, the container, in an upright position with the open end above the closed end, is submerged in the beaker, thereby completely filling the container with water. Any residual air bubbles within the container are expelled by gently shaking container. Thereafter, the container is gently manually grasped by the operator at the neck ring (or neck if no neck ring exists) and lifted out of the beaker, taking care not to spill any of the water contained in the container.

Within two minutes of lifting the container out of the beaker, the outer surface of the container is dried with a cloth and the combined weight of the container and the water contained therein are weighed together. The weight of the empty container is subtracted from the combined weight of the container and the water to determine the weight of the water contained in the container. The weight of water in the container is converted to volume of water by dividing the weight of water contained in the container by the density of the water. This volume of water is recorded as the Immersed Volume. For a flexible container, removing the container completely filled with water from the beaker will result in a drop in the water level within the container since the hydrostatic water pressure acting on the outer surface of the container is removed.

Within five minutes of determining the combined weight of the container and water contained therein, additional water is added to the water already in the container to fill the container to the brim. The combined weight of the container and water contained therein is then measured. The weight of the empty container is subtracted from the combined weight of the container and water to determine the weight of water in the container when the container is filled to the brim without any hydrostatic water pressure acting on the outer surface of the container. This weight of water is converted volume of water by dividing the weight of water contained in the container by the density of water. This volume of water is recorded as the Overflow Volume.

The Container Elasticity Index is calculated as follows and is expressed as a percentage:

Container Elasticity Index=(Overflow volume−Immersed Volume)/Immersed Volume

### Liquid Floor Cleaning Composition

The liquid floor cleaning composition can be an aqueous cleaning compositions. The cleaning composition can comprise at least 95%, optionally at least 97% water by weight of the cleaning composition. Optionally, the cleaning composition can comprise from 95% to 99.93%, optionally from 97% to 99.93%, optionally from 98% to 99.9%, optionally from 98% to 99.5%, optionally from 98% to 99%, water by weight of the cleaning composition.

The cleaning composition can comprise from 0.05% to 0.5% perfume by weight of the cleaning composition. Perfume includes aromatic compounds, including but not limited to, essential oils and synthetic fragrance ingredients and mixtures thereof.

The cleaning composition can comprise 0.02% to 2%, optionally from 0.04% to 1%, optionally from 0.1% to 1%, optionally from about 0.5% to about 0.2%, and any ranges within any of the aforesaid ranges to two decimal places, nonionic surfactant by weight of the cleaning composition. The nonionic surfactant can be an amine oxide surfactant.

The cleaning composition can have a pH from about 4.5 to about 85.

Suitable non-ionic surfactants include amine oxide surfactants which include: R1R2R3NO wherein each of R₁, R₂ and R₃ is independently a saturated or unsaturated, substituted or unsubstituted, linear or branched hydrocarbon chain having from 10 to 30 carbon atoms. Optional amine oxide surfactants are amine oxides having the following formula: R₁R₂R₃NO wherein R₁ is an hydrocarbon chain comprising from 1 to 30 carbon atoms, optionally from 6 to 20, optionally from 8 to 16 and wherein R₁ and R₃ are independently saturated or unsaturated, substituted or unsubstituted, linear or branched hydrocarbon chains comprising from 1 to 4 carbon atoms, optionally from 1 to 3 carbon atoms, optionally are methyl groups. R₁ may be a saturated or unsaturated, substituted or unsubstituted linear or branched hydrocarbon chain.

A suitable amine oxide is C₁₂-C₁₄ dimethyl amine oxide, commercially available from Albright & Wilson, C₁₂-C₁₄ amine oxides commercially available under the trade name GENAMINOX LA from Clariant or AROMOX DMC from Akzo Nobel.

Another suitable non-ionic surfactant is ethoxylated alkoxylated nonionic surfactant. The ethoxylated alkoxylated nonionic surfactant can be selected from the group of: esterified alkyl alkoxylated surfactant; alkyl ethoxy alkoxy alcohol, wherein the alkoxy part of the molecule is optionally propoxy, or butoxy, or propoxy-butoxy; polyoxyalkylene block copolymers, and mixtures thereof.

Optionally, the ethoxylated alkoxylated nonionic surfactant can be an esterified alkyl alkoxylated surfactant of general formula (I):

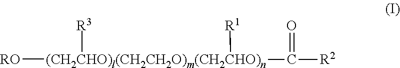

where
R can be a branched or unbranched alkyl radical having 8 to 16 carbon atoms, optionally from 10 to 16, optionally from 12 to 15;
R3, R1 independently of one another, can be hydrogen or a branched or unbranched alkyl radical having 1 to 5 carbon atoms; optionally R3 and R¹ are hydrogen
R2 can be an unbranched alkyl radical having 5 to 17 carbon atoms; optionally from 6 to 14 carbon atoms
1, n independently of one another, can be a number from 1 to 5 and
m can be a number from 8 to 50; and

Optionally, the weight average molecular weight of the ethoxylated alkoxylated nonionic surfactant of formula (I) is from 950 to 2300 g/mol, optionally from 1200 to 1900 g/mol. R is optionally from 12 to 15, optionally 13 carbon atoms. R3 and R1 are optionally hydrogen. Component 1 is optionally 5. n is optionally 1. m is optionally from 13 to 35, optionally 15 to 25, optionally 22. R2 is optionally from 6 to 14 carbon atoms.

The cleaning composition of the invention can provide especially high shine when the esterified alkyl akoxylated surfactant is as follows: R from 12 to 15, optionally 13 carbon atoms, R3 is hydrogen, R1 is hydrogen, component 1 is 5, n is 1, m is from 15 to 25, optionally 22 and R2 has from 6 to 14 carbon atoms and the alcohol ethoxylated has an aliphatic alcohol chain containing from 10 to 14, more optionally 13 carbon atoms and from 5 to 8, optionally 7 molecules of ethylene oxide.

Optionally, the ethoxylated alkoxylated nonionic surfactant can be a polyoxyalkylene copolymer. The polyoxyalkylene copolymer can be a block-heteric ethoxylated alkoxylated nonionic surfactant, though block-block surfactants are practical. Suitable polyoxyalkylene block copolymers include ethylene oxide/propylene oxide block polymers, of formula (II):

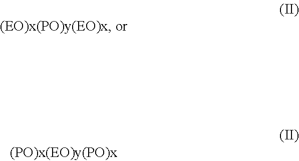

wherein EO represents an ethylene oxide unit, PO represents a propylene oxide unit, and x and y are numbers detailing the average number of moles ethylene oxide and propylene oxide in each mole of product. Such materials tend to have higher molecular weights than most non-ionic surfactants, and as such can range between 1000 and 30000 g/mol, although the molecular weight can be above 2200 and optionally below 13000 or within those ranges. A practical range for the molecular weight of the polymeric non-ionic surfactant is from 2400 to 11500 Daltons. BASF (Mount Olive, N.J.) manufactures a suitable set of derivatives and markets them under the PLURONIC trademarks. Examples of these are PLURONIC F77, L62 and F88 which have the molecular weight of 6600, 2450 and 11400 g/mol respectively. A possible useful polymeric non-ionic surfactant is PLURONIC F77.

Other suitable ethoxylated alkoxylated nonionic surfactants are described in Chapter 7 of Surfactant Science and Technology, Third Edition, Wiley Press, ISBN 978-0-471-68024-6. The ethoxylated alkoxylated nonionic surfactant can provide a wetting effect of from 15 to 350 s, optionally from 60 to 200 s, optionally from 75 to 150 s. The wetting effect is measured according to EN 1772, using 1 g/l of the ethoxylated alkoxylated nonionic surfactant in distilled water, at 23° C., with 2 g soda/l.

The ethoxylated alkoxylated nonionic surfactants can be low foaming non-ionic surfactants that are alkoxylated and include unbranched fatty alcohols that may contain high amounts of alkene oxide and ethylene oxide. For example, ethoxylated alkoxylated nonionic surfactants may include those sold by BASF under the PLURAFAC trademark, such as PLURAFAC LF 131 (wetting effect of 25 s), LF 132 (wetting effect of 70 s), LF 231 (wetting effect of 40 s), LF 431 (wetting effect of 30 s), LF 1530 (wetting effect >300 s), LF 731 (wetting effect of 100 s), LF 1430 (wetting effect >300 s) and LF 7319 (wetting effect of 100 s). The ethoxylated alkoxylated nonionic surfactants optionally are not hydrogenated and, therefore, the fatty alcohol chains do not terminate in a hydrogen group. Examples of such hydrogenated non-ionic surfactants include PLURAFAC 305 and PLURAFAC 204.

Other suitable nonionic surfactants include alkoxylated nonionic surfactants, alkyl polyglycosides, and mixture thereof. Suitable alkoxylated nonionic surfactants include primary C₆-C₁₆ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons and alternative reference to for example EO8 is meant average ethylene oxide units.

Suitable alkoxylated nonionic surfactants can be according to the formula RO-(A)ₙH, wherein: R is a C₆ to C₁₈, optionally a C₈ to C₁₆, optionally a C₈ to C₁₂ alkyl chain, or a C₆ to C₂₈ alkyl benzene chain; A can be an ethoxy or propoxy or butoxy unit, and wherein n is from 1 to 30, optionally from 1 to 15 and, optionally from 4 to 12, optionally 5 to 10. Optional R chains for use herein are the C₉ to C₁₁ alkyl chains. Further optionally, R chains for use herein can be C₉ to C₁₂ alkyl chains. R can be linear or branched alkyl chain.

Suitable ethoxylated nonionic surfactants for use herein can be DOBANOL 91-2.5 (HLB=8.1; R is a mixture of C₉ and C₁₁ alkyl chains, n is 2.5), DOBANOL 91-10 (HLB=14.2; R is a mixture of C, to Cy alkyl chains, n is 10), DOBANOL 91-12 (HLB=14.5; R is a mixture of Co to Cy alkyl chains, n is 12), GREENBENTINE DE80 (HLB=13.8, 98 wt % C10 linear alkyl chain, n is 8), MARLIPAL 10-8 (HLB=13.8, R is a C10 linear alkyl chain, n is 8), LIALETHL 11-5 (R is a C₁₁ alkyl chain, n is 5), ISALCHEM 11-5 (R is a mixture of linear and branched C11 alkyl chain, n is 5), LIALETHL 11-21 (R is a mixture of linear and branched C₁₁ alkyl chain, n is 21), ISALCHEM 11-21 (R is a C₁₁ branched alkyl chain, n is 21), EMPILAN KBE21 (R is a mixture of C₁₂ and C₁₄ alkyl chains, n is 21) or mixtures thereof. Optionally and practical are DOBANOL 91-5, NEODOL 11-5, LIALETHL 11-21 LIALETHL 11-5 ISALCHEM 11-5 ISALCHEM 11-21 DOBANOL 91-8, or DOBANOL 91-10, or DOBANOL 91-12, or mixtures thereof. These DOBANOL/NEODOL surfactants are commercially available from Shell Chemicals. These LUTENSOL surfactants are commercially available from BASF and these TERGITOL surfactants are commercially available from Dow Chemicals.

Suitable chemical processes for preparing the alkoxylated nonionic surfactants for use herein include condensation of corresponding alcohols with alkylene oxide, in the desired proportions. Such processes are well known to the person skilled in the art and have been extensively described in the art, including the OXO process and various derivatives thereof. Suitable alkoxylated fatty alcohol nonionic surfactants, produced using the OXO process, have been marketed under the tradename NEODOL by the Shell Chemical Company. Alternatively, suitable alkoxylated nonionic surfactants can be prepared by other processes such as the Ziegler process, in addition to derivatives of the OXO or Ziegler processes.

Optionally, said alkoxylated nonionic surfactant is a C₉₋₁₁ EO5 alkylethoxylate, C₁₂₋₁₄ EO5 alkylethoxylate, a C₁₁ EO5 alkylethoxylate, C₁₂₋₁₄ EO21 alkylethoxylate, or a C₉₋₁₁ EO8 alkylethoxylate or a mixture thereof. Further optionally, said alkoxylated nonionic surfactant can be a C₁₁ EO5 alkylethoxylate or a C₉₋₁₁ EO8 alkylethoxylate or a mixture thereof. Another suitable non-ionic surfactants can be alkyl polyglycosides, which are biodegradable nonionic surfactants which are well known in the art. Suitable alkyl polyglycosides can have the general formula CₙH₂ₙ₊₁O(C₆H₁₀O₅)ₓH wherein n is optionally from 9 to 16, optionally 11 to 14, and x is optionally from 1 to 2, optionally 1.3 to 1.6. Such alkyl polyglycosides provide a good balance between anti-foam activity and detergency. Alkyl polyglycoside surfactants are commercially available in a large variety. An example of a very suitable alkyl poly glycoside product is PLANTEREN APG 600, which is essentially an aqueous dispersion of alkyl polyglycosides wherein n is about 13 and x is about 1.4.

The additional nonionic surfactant can be a low molecular weight nonionic surfactant, having a molecular weight of less than 950 g/mol, optionally less than 500 g/mol.

Other suitable non-ionic surfactants include zwitterionic surfactants. Zwitterionic surfactants typically contain both cationic and anionic groups in substantially equivalent proportions so as to be electrically neutral at the pH of use. The typical cationic group is a quaternary ammonium group, other positively charged groups like phosphonium, imidazolium and sulfonium groups can be used. The typical anionic hydrophilic groups are carboxylates and sulfonates, although other groups like sulfates, phosphonates, and the like can be used. Some common examples of zwitterionic surfactants (such as betaine/sulphobetaine surfactants) are described in U.S. Pat. Nos. 2,082,275, 2,702,279 and 2,255,082. For example, coconut dimethyl betaine is commercially available from Seppic under the trade name of AMONYL 265. Lauryl betaine is commercially available from Albright & Wilson under the trade name EMPIGEN BB/L. A further example of betaine is Lauryl-imminodipropionate commercially available from Rhodia under the trade name MIRATAINE H2C-HA.

Sulfobetaine surfactants are practical, since they can improve soap scum cleaning. Examples of suitable sulfobetaine surfactants include tallow bis(hydroxyethyl) sulphobetaine, cocoamido propyl hydroxy sulphobetaines which are commercially available from Rhodia and Witco, under the trade name of MIRATAINE CBS and REWOTERIC AM CAS 15, respectively.

Other suitable non-ionic surfactants include amphoteric surfactants. Amphoteric surfactants can be either cationic or anionic depending upon the pH of the cleaning composition. Suitable amphoteric surfactants include dodecylbeta-alanine, N-alkyltaurines such as the one prepared by reacting dodecylamine with sodium isethionate, as taught in U.S. Pat. No. 2,658,072, N-higher alkylaspartic acids such as those taught in U.S. Pat. No. 2,438,091, and the products sold under the trade name MIRANOL, as described in U.S. Pat. No. 2,528,378. Other suitable additional surfactants can be found in Mccutcheon's Detergents and Emulsifers, North American Ed. 1980.

The cleaning composition can comprise a solvent system comprising a mixture of at least two glycol ether solvents. The solvent system can comprise a first glycol ether solvent with an HLB value of 6.5 to 7.0 and a second glycol ether solvent with an HLB value of 6.0 to 6.5. The selection of a solvent system typically involves a dual solvent system wherein the higher level (by weight) solvent has a low boiling point to promote evaporation and the lower level solvent (by weight) is selected to deliver a secondary benefit such as solubility, wetting, or diffusion.

In the present disclosure, a solvent is selected for its level of water solubility or its Hydrophilic-Lipophilic Balance or HLB value. The lower the HLB value the less water soluble the solvent and the more oil soluble or oil compatible. For example, an HLB value of 0 corresponds to a completely lipophilic/hydrophobic molecule or oil soluble molecule, and an HLB value of 20 corresponds to a completely hydrophilic/lipophobic or water soluble molecule.

A cleaning composition having one glycol ether solvent with an HLB value of 6.5 to 7.0 and a second glycol ether solvent with an HLB value of 6.0 to 6.5 can deliver good cleaning with an unexpectedly faster drying time as compared to cleaning compositions with traditional solvent systems.

Without being bound by theory, a cleaning composition having a solvent or solvents with the optional HLB values provides sufficient water solubility for solution stability and enough oil compatibility for oil or lipid solubility, especially for a cleaning composition having a relatively high level of water. The solvents or solvents with optional HLB values deliver optimum oil solubility for cleaning, soil dissolution, and absorption while maintaining a reasonable level of evaporation required for fast drying.

A glycol ether having an HLB between 6.5 and 7.0 may be selected from the group of: propylene glycol n-butyl ether, dipropylene glycol n-butyl ether, and combinations thereof. Exemplary glycol ethers having an HLB between 6.5 and 7.0 are DOWANOL PnB and DOWANOL DPnB Glycol Ether from the Dow Chemical Company.

A glycol ether having an HLB between 6.0 and 6.5 can be selected from the group consisting of: ethylene glycol monohexyl ether, ethylene glycol phenyl ether, and combinations thereof. Exemplary glycol ethers having an HLB between 6.0 and 6.5 are Hexyl CELLOSOLVE and DOWANOL EPH from the Dow Chemical Company.

The glycol ether solvent having an HLB between 6.5 and 7.0 may be present at a level of 0.15 wt. % to 1.50 wt. %, optionally 0.2 wt. % to 1.0 wt. %, optionally 0.3 wt. % to 0.7 wt. %, by weight of the cleaning composition.

The glycol ether solvent having an HLB between 6.0 and 6.5 may be present at a level of 0.10 wt. % to 0.50 wt. %, optionally 0.2 wt. % to 0.45 wt. %, optionally 0.3 wt. % to 0.4 wt. %, by weight of the overall cleaning composition.

The cleaning composition may comprise less than 0.5 wt. % ethanol, optionally less than 0.4 wt. % ethanol, optionally less than 0.3 wt. % ethanol. Without wishing to be bound by theory, it is believed that higher levels of ethanol negatively impact the advancing contact angle of the cleaning composition and increases the drying time of the cleaning composition.

### Combinations

An example is below:
A. A floor cleaning product comprising:
a container (10) comprising:
an open end (20) surrounding a longitudinal axis (L) passing through said open end;
a neck (30) extending from said open end and around said longitudinal axis;
a closed end (40) opposite said open end, wherein said longitudinal axis extends through said closed end, wherein said container has a transverse section midway between said open end and said closed end, wherein said transverse section is orthogonal to said longitudinal axis;
a front panel (50) extending between a pair of sidewalls (60), wherein between said sidewalls along said transverse section said front panel is convex relative to said longitudinal axis; and
a rear panel (70) opposite said front panel and extending between said sidewalls, wherein said rear panel has a recess (80) sized and dimensioned to receive part of distal phalanxes of digits two through five of an adult human hand, wherein said container has a container height measured along said longitudinal axis from said closed end to said open, wherein said recess extends in a direction aligned with said longitudinal axis by from about 25% to about 60% of said container height;
a flip top closure (90) comprising:
a top profile (100) having an exterior surface (120) and interior surface (130) opposite said exterior surface;
a hinge (150) engaging said top profile to a main body (160);
an outlet face (180) oriented towards said top profile, wherein said outlet face comprises from about 6 to about 10 apertures, wherein each of said apertures has a diameter from about 0.3 mm to about 1.5 mm;
a skirt (210) extending from said main body and oriented away from said top profile, wherein said skirt has an skirt interior surface (220) oriented towards said longitudinal axis, wherein said skirt interior surface is engaged with said neck; and
a liquid floor cleaning composition comprising:
0.02% to 2% nonionic surfactant by weight of said composition;
0.05% to 0.5% perfume by weight of said composition; and
at least 95% water by weight of said composition;
wherein said composition has a pH from 4.5 to 8.5.
B. The floor cleaning product according to Paragraph A, wherein a majority of said recess is positioned between said transverse section and said open end.
C. The floor cleaning product according to Paragraph A or B, wherein said container has a coronal plane (CP) between said front panel and said rear panel and passing through said longitudinal axis, wherein said hinge and said rear panel are on the same side of said coronal plane.
D. The floor cleaning product according to any of Paragraphs A to C, wherein said hinge is parallel to said coronal plane.
E. The floor cleaning product according to any of Paragraphs A to D, wherein said container has an interior volume in a free standing condition that is from about 200 mL to about 1500 mL.
F. The floor cleaning product according to any of Paragraphs A to E, wherein said recess has a maximum recess depth relative to portions of said rear panel immediately surrounding said recess that is from about 4 mm to about 8 mm.
G. The floor cleaning product according to any of Paragraphs A to F, wherein said front panel has a center (52) on said transverse section midway between said sidewalls wherein interior to said container said recess is from about 40 mm to about 60 mm away from said recess as measured through and orthogonal to said longitudinal axis.
H. The floor cleaning product according to any of Paragraphs A to G, wherein said skirt interior surface comprises threads (222), wherein said neck comprises complimentary threads (222), wherein said threads are engaged with said complementary threads.
I. The floor cleaning product according to any of Paragraphs A to H, wherein said recess has a recess height (82) measured parallel to said longitudinal axis that is from about 60 mm to about 130 mm and a maximum recess depth relative to portions of said rear panel immediately surrounding said recess that is about 3% to about 13% of said recess height.
J. The floor cleaning product according to any of Paragraphs A to I, wherein said recess has a maximum recess width 84 measured orthogonal to said longitudinal axis that is from about 20 mm to about 40 mm.
K. The floor cleaning product according to any of Paragraphs A to J, wherein said front panel has a center (52) on said transverse section midway between said sidewalls and a grip distance (53) from said center to said recess measured along said transverse section exterior of said container from about 90 mm to about 140 mm.
L. The floor cleaning product according to any of Paragraphs A to K, wherein at least a portion of said recess is coincident with said transverse section.
M. The floor cleaning product according to any of Paragraphs A to L, wherein said container has a Container Elasticity Index from about 0.35% to about 0.65%.
N. The floor cleaning product according to any of Paragraphs A to M, wherein said container has a Force at 25 mm of Deformation from about 30 N to about 60 N.
O. The floor cleaning product according to any of Paragraphs A to N, wherein said flip top closure further comprises a spud (140) projecting from said skirt interior surface and an abutment (170) in said main body sealingly engaged with said spud, wherein said abutment extends around said longitudinal axis, and wherein said apertures are inboard of said abutment.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A floor cleaning product comprising:
a container comprising:
an open end surrounding a longitudinal axis passing through said open end;
a neck extending from said open end and around said longitudinal axis;
a closed end opposite said open end, wherein said longitudinal axis extends through said closed end, wherein said container has a transverse section midway between said open end and said closed end, wherein said transverse section is orthogonal to said longitudinal axis;
a front panel extending between a pair of sidewalls, wherein between said sidewalls along said transverse section said front panel is convex relative to said longitudinal axis; and
a rear panel opposite said front panel and extending between said sidewalls, wherein said rear panel has a recess sized and dimensioned to receive part of distal phalanxes of digits two through five of an adult human hand, wherein said container has a container height measured along said longitudinal axis from said closed end to said open, wherein said recess extends in a direction aligned with said longitudinal axis by from about 25% to about 60% of said container height;
a flip top closure comprising:
a top profile having an exterior surface and interior surface opposite said exterior surface;
a hinge engaging said top profile to a main body;
an outlet face oriented towards said top profile, wherein said outlet face comprises from about 6 to about 10 apertures inboard of said abutment, wherein each of said apertures has a diameter from about 0.3 mm to about 1.5 mm;
a skirt extending from said main body and oriented away from said top profile, wherein said skirt has an skirt interior surface oriented towards said longitudinal axis, wherein said skirt interior surface is engaged with said neck; and
a liquid floor cleaning composition comprising:
0.02% to 0.2% nonionic surfactant by weight of said composition;
0.05% to 0.5% perfume by weight of said composition; and
at least 95% water by weight of said composition;
wherein said composition has a pH from 4.5 to 8.5.

2. The floor cleaning product according to claim 1, wherein a majority of said recess is positioned between said transverse section and said open end.

3. The floor cleaning product according to claim 1, wherein said container has a coronal plane between said front panel and said rear panel and passing through said longitudinal axis, wherein said hinge and said rear panel are on the same side of said coronal plane.

4. The floor cleaning product according to claim 3, wherein said hinge is parallel to said coronal plane.

5. The floor cleaning product according to claim 3, wherein said front panel has a center on said transverse section midway between said sidewalls wherein interior to said container said recess is from about 40 mm to about 60 mm away from said recess as measured through and orthogonal to said longitudinal axis.

6. The floor cleaning product according to claim 5, wherein said recess has a maximum recess depth relative to portions of said rear panel immediately surrounding said recess that is from about 4 mm to about 8 mm.

7. The floor cleaning product according to claim 5, wherein said recess has a recess height measured parallel to said longitudinal axis that is from about 60 mm to about 130 mm and a maximum recess depth relative to portions of said rear panel immediately surrounding said recess that is about 3% to about 13% of said recess height.

8. The floor cleaning product according to claim 7, wherein said recess has a maximum recess width measured orthogonal to said longitudinal axis that is from about 20 mm to about 40 mm.

9. The floor cleaning product according to claim 1, wherein said container has an interior volume in a free standing condition that is from about 200 mL to about 1500 mL.

10. The floor cleaning product according to claim 1, wherein said skirt interior surface comprises threads, wherein said neck comprises complimentary threads, wherein said threads are engaged with said complementary threads.

11. The floor cleaning product according to claim 1, wherein said front panel has a center on said transverse section midway between said sidewalls and a grip distance from said center to said recess measured along said transverse section exterior of said container from about 90 mm to about 140 mm.

12. The floor cleaning product according to claim 1, wherein at least a portion of said recess is coincident with said transverse section.

13. The floor cleaning product according to claim 1, wherein said container has a Container Elasticity Index from about 0.35% to about 0.65%.

14. The floor cleaning product according to claim 1, wherein said container has a Force at 25 mm of Deformation from about 30 N to about 60 N.

15. The floor cleaning product according to claim 1, wherein flip top closure further comprises a spud projecting from said interior surface and an abutment in said main body sealingly engaged with said spud, wherein said abutment extends around said longitudinal axis, and wherein said apertures are inboard of said abutment.

16. The floor cleaning product according to claim 1, wherein said front panel has a center on said transverse section midway between said sidewalls wherein interior to said container said recess is from about 40 mm to about 60 mm away from said recess as measured through and orthogonal to said longitudinal axis.

17. The floor cleaning product according to claim 16, wherein said recess has a maximum recess depth relative to portions of said rear panel immediately surrounding said recess that is from about 4 mm to about 8 mm.

18. The floor cleaning product according to claim 17, wherein said recess has a recess height measured parallel to said longitudinal axis that is from about 60 mm to about 130 mm and a maximum recess depth relative to portions of said rear panel immediately surrounding said recess that is about 3% to about 13% of said recess height.

19. The floor cleaning product according to claim 18, wherein said recess has a maximum recess width measured orthogonal to said longitudinal axis that is from about 20 mm to about 40 mm.

20. The floor cleaning product according to claim 19, wherein said front panel has a center on said transverse section midway between said sidewalls and a grip distance from said center to said recess measured along said transverse section exterior of said container from about 90 mm to about 140 mm.
